(19) United States
(12) Patent Application Publication
(10) Pub. No.: US 2018/0363182 A1
(43) Pub. Date: Dec. 20, 2018

(54) PROCESS FOR PRODUCING IMPRINTED SHEET MATERIALS

(71) Applicant: SCA Hygiene Products AB, Göteborg (SE)

(72) Inventors: Jörg BERGMANN, Neuss (DE); Bareld MEIJERING, Suameer (NL); Mikael STRANDQVIST, Gotëborg (SE)

(73) Assignee: SCA Hygiene Products AB, Göteborg (SE)

(21) Appl. No.: 16/060,211

(22) PCT Filed: Dec. 8, 2015
(86) PCT No.: PCT/EP2015/078998

§ 371 Date: Jun. 7, 2018

(51) Int. Cl. D04H 1/495; B29C 65/00; D04H 1/541

(52) U.S. Cl. CPC D04H 1/495; D04H 1/541; B29C 66/83411; B29C 66/9241

(57) ABSTRACT

An imprinted or compressed sheet material can be produced by subjecting a pre-dried composite material to an energy transfer step in which the sheet material is passed between an energy-emitting device and a patterned anvil. An oil is applied to the anvil after the passing of the sheet material and the applied oil is removed from the anvil before the next passing of the sheet material. An apparatus for continuously producing such a sheet material includes a patterned anvil roll, an energy transmitter emitting ultrasound energy to the anvil roll, a means for applying an oil over the breadth of the anvil roll and a means for removing oil from the roll downstream of the means for applying the oil.

### CROSS-REFERENCE TO PRIOR APPLICATION

This application is a § 371 National Stage Application of PCT International Application No. PCT/EP2015/078998 filed Dec. 8, 2015, which is incorporated herein in its entirety.

### TECHNICAL FIELD

The present disclosure relates to a process for producing an imprinted or bonded sheet material and to an apparatus for producing such imprinted or bonded sheet material.

### BACKGROUND

Absorbent nonwoven materials are used for wiping various types of spills and dirt in industrial, medical, office and household applications. They typically include a combination of theititoplastic polymers (synthetic fibres) and cellulosic pulp for absorbing water and other hydrophilic substances, as well as hydrophobic substances (oils, fats). The nonwoven wipes of this type, in addition to having sufficient absorptive power, are at the same time strong, flexible and soft. They can be produced by various methods, including air-laying, wet-laying and foam-laying of a pulp-containing mixture on a polymer web, followed by dewatering and hydroentangling to anchor the pulp onto the polymer, and final drying. Absorbent nonwoven materials of this type and their production processes are disclosed i.a. in WO 2005/042819, WO 2007/108725, WO 2008/066417 and WO 2009/031951.

For various applications, it is desired to have visible patterns, such as figures, logotypes, text and the like, onto the nonwoven materials, so as to make them identifiable, for indicating their intended use, for promotional purposes etc. Patterns can be applied by printing; however, printing often results in bleeding of the ink into the nonwoven outside the pattern, e.g. when a wipe or the like is used together with solvents during use of the wipe (wiping), which is clearly undesired. For other applications, it is desired to achieve a degree of bonding of the thermoplastic fibres and the pulp fibres by exerting pressure

Page 2 and/or heat onto the mixed fibres. This bonding may be performed instead of, or in addition to bonding through water jets (hydroentangling).

WO 95/09261 discloses nonwoven materials having geometrically repeating patterns that are formed by bonded and unbonded regions on the material. The nonwoven materials are three-layered laminates having outer spun-bound thermoplastic layers and an inner melt-blown fibre layer. The laminates are patterned by calendering using heated embossing rolls; ultrasonic bonding is mentioned as an alternative. A drawback of these materials is that the pattern is connected to bonding of the thermoplast and that, as a consequence, the patterns can only be small and at the same time must occupy a relatively large area of the nonwoven surface. This is particularly disadvantageous for absorbent nonwoven materials, containing cellulose pulp or the like, where bonding reduces the absorptive power and thermo-bonding is therefore preferably avoided.

Ultrasonic treatment is known in the art for providing bonding or welding energy to sheet materials. However, high-speed rotatory ultrasonic technology for treating pulp-containing nonwovens suffers from contamination of the anvil roll after relatively short periods of operation, especially in case of patterned anvil rolls; this requires frequent cleaning steps, and results in imperfections or even holes in the produced sheet material as a result of undue sticking of the sheet to the anvil after the treatment, and in possible jamming of the equipment and hence in an inefficient operation of the process. Moistening of the sheet material has been proposed for reducing the effects of contamination in ultrasonic welding; however, this requires additional drying steps and may lead to corrosion and increased wear of the equipment. Another prior art approach is to treat the anvil roll to provide it with nanostructures that prevent contamination; however, this treatment appears not be effective for pulp-containing and similar materials.

### SUMMARY

It is desired to provide a process for producing pulp-containing nonwoven sheet material involving oscillation energy treatment, such as ultrasonic treatment, in which contamination of the energy-emitting equipment is reduced or avoided, and which can be operated at high throughput. This is accomplished by adding an oil to the anvil to form a thin oil film on the relevant surfaces after the passing of the sheet material and removing used oil by, for example brushing off the used oil prior to the next passing of sheet material. This results in a strongly reduced contamination and reduced wearing effects on the equipment and the product.

It is further desired to provide a patterned pulp-containing sheet material having substantially no surface imperfections beyond the patterning, in particular no holes, which material can be obtained by the above process.

It is also desired to provide an apparatus for applying oscillating energy onto a sheet material for imprinting or bonding purposes, which avoids contamination of the sheet material.

### BRIEF DESCRIPTION OF THE DRAWINGS

The accompanying FIGURE diagrammatically depicts an installation for producing a nonwoven sheet material, which installation includes an apparatus for imprinting a sheet material according to the present disclosure.

### DETAILED DESCRIPTION OF PARTICULAR EMBODIMENTS

The process for producing a sheet material as described above includes passing dried composite, pulp-containing sheet material between an energy-emitting device and a patterned anvil, wherein an oil is applied to the anvil after the passing of the sheet material and the applied oil is largely or essentially completely removed from the anvil before the next passing of the sheet material.

With the present process and the present equipment, any spent material, dust-like or other, originating from the passing sheet, in particular any pulp-derived material, is absorbed into the oil and is then removed together with the spent oil. This causes the anvil, especially the protruded parts thereof forming an imprinting or compressing pattern, to be cleaned and hence to avoid surface effects on the imprinted sheet and to avoid jamming of the anvil roll.

The energy transfer step is especially based on vibrational energy rather than by direct impact or heat. For providing a pattern by imprinting, it is important that the imprinting action does not include embossing or thermo-bonding of thermoplastic fibres to a significant degree. Embossing (with moderately heated rolls) was found to result in less sharp patterns and thermo-bonding (which implies melting of the thermoplast) reduces the absorptive power of the resulting sheet material. On the other hand, where the energy transfer treatment is used for providing bonding in the composite sheet, some heat will not be detrimental to the sheet properties, or may even be desired.

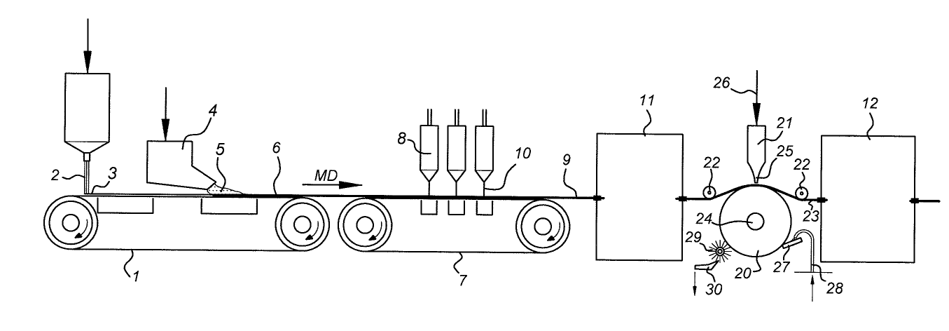

A very useful type of vibrational (oscillating) energy is ultrasound energy. Thus, the process can include ultrasonic imprinting to produce a patterned sheet material. In a particular embodiment, the imprinting action is a rotatory action using a patterned anvil roll which conveys the sheet material to be imprinted, as shown in the accompanying FIG. 1, and as further described below.

The oil to be used for applying onto the anvil can be any oil that is sufficiently inert under the processing conditions, which typically imply the presence of air and temperatures between ambient and, say, 100° C. Thus, the oil should have low iodine values and low peroxide values. The oil should have low volatility and high flame points; for example, the boiling point at ambient conditions should be at least 250° C. and the flash point at least 200° C. The oil should not be too viscous, since that would hinder a smooth application and subsequent removal of the oil. In particular embodiments, the pour point is below 0° C. It should also not be too thin, in order to avoid the risk of dripping and the like. In particular embodiments, the oil has a (kinematic) viscosity of at least 10 and no more than 200 mm²/s (centistokes, cSt), of 20-100 mm²/s, or of 50-80 mm²/s at 40° C.

Particularly suitable are oils that are based on hydrocarbons or silanes or siloxanes or non-reactive derivatives thereof such as (poly)ethers and (poly)esters that do not contain unsaturations other than aromatic unsaturations. In embodiments, the hydrocarbons or sil(ox)anes are fully saturated, i.e. aliphatic or alicyclic. In a special embodiment, the oil is a saturated hydrocarbon or a saturated siloxane having at least 20 carbon and/or silicon atoms, up to e.g. 120 carbon and/or silicon atoms, or up to 60 carbon atoms in case of hydrocarbons. Mineral oils and silicone oils are well suited for the purpose. Mixtures of oils, or mixture of an oil and further components such as polyols may also be used.

The oil can be applied by various spreading methods, including spraying, dripping, wiping, brushing, rubbing, sweeping, smearing and the like, all of which result in the oil being spread over the anvil's surface and in particular over the protrusions thereon, where the oil has its major function. A particular manner of applying the oil is to rub it using a suitable porous textile shaped material such as a felt, which is lightly pressed against the running anvil. Felts or other oil-dispensing devices are widely commercially available in any shape or size. In particular embodiments, the pressure is such that the oil is at least spread onto the protruding parts of the anvil surface forming the pattern that is subjected to the energy-transmitting (e.g. ultrasound) imprinting. The amount of oil to be applied may vary depending on the specific properties of the sheet material being produced, e.g. depending on the level of pulp material in the sheet. Advantageously, the amount of oil that is applied will be at least 0.02 μl, up to e.g. 20 between 0.1 and 10 μl, or between 0.5 and 7 μl per m² of sheet material passing the anvil.

The oil, after having absorbed any dust or other residual matter originating from the passing sheet material, is then removed from the anvil in an appropriate manner. For example, the residual oil can be removed by an oil remover such as a means capable of brushing, scraping, wiping, blowing, jet-spraying or the like, over the breadth of the anvil roll. A suitable way of removing the oil is by pressing a roller brush against the moving anvil, which accepts the oil as a result of a sweeping (brushing) and/or absorbing action. Brushes or other oil-removing devices are widely commercially available in any form or size. In particular embodiments, the pressure is such that the brush removes a least the oil that is present on the protruding parts of the (patterned) anvil. Such a roller brush may in turn be in contact with a scrape or further roll which allows the spent oil to be drawn off. The oil may also be removed e.g. by using compressed air, optionally also with water, provided by an oil remover that in large corresponds to a printer plate cleaner available from Tresu Group. Such an oil remover would remove the oil by blowing air onto the anvil surface, optionally together with water, and then removing reflected air (and water) together with oil from the anvil surface by suction. Advantageously, the used oil may be cleaned, e.g. by filtering, and reused.

The present process of reducing contamination and wear of the equipment by applying and removing oil may result in minor amounts of oil not being removed from the anvil and very low levels being traceable in the sheet product. However, such residual levels of oil, as defined above, in the final sheet product will be less than 5 ppm, especially between 0.1 and 1.0 ppm.

In a particular embodiment, the anvil is a rotating cylinder (roll), at the top of which the energy-supplying (ultrasonic) device is mounted. The device for applying oil (e.g. a felt) is mounted within the second or third radian (of the in total 2π radians of the cylinder) from the energy device along the direction of movement of the rotating cylinder, and the device for removing the oil (e.g. a brush) is mounted within the third, fourth or fifth radian in the same direction. A suitable equipment is shown in the accompanying figure and described in more detail below.

Thus, an apparatus for continuously imprinting a sheet material according to the present disclosure includes a patterned anvil roll, an energy transmitter emitting oscillating energy, in particular ultrasound energy to the anvil roll at a distance from the anvil roll, a means for rotating the anvil roll, a means for applying an oil over the breadth of the anvil roll downstream of the energy transmitter and a means for removing the roll downstream of the means for applying the oil. In particular embodiments, the oscillating frequency is in the upper acoustic range or, in more particular embodiments, in the lower ultrasound range, e.g. between 15 and 100 kHz, especially between 18 and 30 kHz. In particular, the oscillating power is in the range of 200-4000 N, or 500-2500 N. The oscillating amplitude will typically be in the range of 10-100 μm.

The distance between the energy-emitting unit (which is sometimes referred to as sonotrode in an ultrasound equipment) and the anvil can be short and may vary in operation. Thus, the clearance between the energy transmitter and protruding parts of the anvil roll has a maximum which is approximately equivalent to or larger than the thickness of the material to be treated and a minimum (imprinting stage) which is somewhat less than the thickness of the material treated. Thus, the clearance can be at least 500 gm, between 600 and 2000 μm, or between 800 and 1500 μm. In particular embodiments, the clearance is adjustable, so as to allow replacement and processing of sheets of different thicknesses.

The anvil roll has suitable dimensions for allowing a continuous sheet to be moved at a significant speed of e.g. 2-10 m/sec, or 3-6 m/sec (180-360 m/min). The anvil roll may have a diameter of e.g. 50-200 cm and a breadth (height of the cylinder) of between 1 and 3 m. The rotating speed is controllable and, for an anvil roll of 1 m diameter, the rotating speed (in radians per s) will be the same as the speed of the passing sheet, i.e. the tangential speed of the rotating roll, corresponding to e.g. 25-60 revolutions per minute (rpm). It is important to ensure that the rotating speed is closely adjusted to the transporting speed of the sheet, so that the sheet does not move with respect to the anvil while it is in contact with the anvil, and damage to the sheet material is avoided.

Ambient conditions can suitably be applied during the ultrasound treatment. In particular embodiments, the temperature of the sheet at the imprinting site is less than 100° C., less than 60° C., or between 30 and 50° C., when imprinting for producing a patterned nonwoven sheet material.

An apparatus according to the present disclosure is depicted in the accompanying figure. Untreated continuous semi-finalised sheet material 9 is conveyed over anvil 20 along guiding rolls 22 to produce treated sheet material 23. The anvil roll 20 is activated by driving gear 24, which in this figure rotates clockwise. Ultrasound energy is applied by horn 21 provided with sonotrode 25 and oscillation boosters 26. A felt 27 with oil supply 28 is pressed against the anvil and brush 29 is pressed against the anvil at a certain distance from the oil-proving felt, and is provided with a scraper 30 for removing and carrying off spent oil from the brush.

Ultrasound equipment suitable for use in the present process is commonly known in the art. As an example, ultrasonic equipment can be purchased e.g. from Herrmann Ultraschall, Karlsbad, Del., or from Branson Ultrasonics, Danbury Conn., USA or Dietzenbach, Del.

A pulp-containing nonwoven sheet material which is obtainable by the process as described above is also part of the present disclosure.

The sheet material produced by the present process may have a varying composition. It typically contains cellulosic pulp, such as wood pulp, at a level of at least 25 wt. % of the total dry matter of the product. In particular embodiments, the sheet contains at least 40 wt. %, at least 50 wt. % up to 90 wt. %, up to 80 wt. %, or between 60 and 75 wt. % of cellulosic fibres. Cellulosic fibres are further defined below and include cellulosic pulp. Where weight ratios or percentages are mentioned herein, these are on dry matter basis, unless otherwise specified.

In addition, the sheet material may contain thermoplastic fibres, at least 10 wt. %, at least 15 wt. %, at least 20 wt. %, or at least 25 wt. %, and up to e.g. 70 wt. %, up to 50 wt. %, or up to 40 wt. %. The thermoplastic fibres, also referred to as (manmade or synthetic) polymer fibres, can include continuous filaments or (short) staples or both. In a particular embodiment, the sheet material contains both thermoplastic filaments and staple fibres, e.g. in a weight ratio between 9:1 and 1:1, or between 5:1 and 1.5:1. Thermoplastic fibres are further described and illustrated below.

The thickness of the sheet material produced by the present process may vary widely, depending on the intended use. As an example, the sheet may have thicknesses (on non-imprinted parts) between 100 and 2000 μm, in particular of 250-1000 μm, or 500-800 ↑m. The thickness can be measured by the method as further described in the accompanying examples. The height difference between imprinted (pattern) and non-imprinted parts of 50-250 μm, or 75-150 μm. The height difference can be measured by methods known in the art, e.g. by laser reflection measurement or by white light interference measurement.

In the embodiment of patterning a sheet material, between 1 and 20% of at least one surface may been imprinted and form a pattern that is discernible by visual and/or tactile means, e.g. by differences in reflection, brightness, smoothness, etc. between imprinted and non-imprinted part, which can be perceived visually or by touch and feel. These differences are in particular differences in height.

As used herein, imprinting is understood to mean exercising a mechanical force resulting in some compression of the sheet material, as further defined and illustrated below. Thus, the patterns are not exclusively discernible by difference in colour, e.g. resulting from printing, dyeing or inking, or in other differences in material composition. In a particular embodiment, the patterns essentially only result from imprinting. In particular, the imprinted part of the sheet material has a thickness which is between 75 and 95% of the thickness of the non-imprinted part. Thus, the imprinting action results in a 5-25% reduced thickness.

The patterns can be present at either side of the sheet material or on both sides. In a particular embodiment, the patterning (i.e. the height differences) are present on one side only, which is called “front side”, or “pattern side” for easy reference. The front side can have the same or a different material composition as the back side. The sheet material may have a largely homogeneous composition over its thickness. Alternatively, the sheet material may have a gradually changing composition over its thickness, with the two surfaces (front and back) having essentially the same composition (in which case internal areas have a different composition) or a different composition. In a special embodiment, the sheet material is a layered sheet, with two, three of more layers of different composition, wherein, however, in particular as a result of the hydroentanglement, there are no sharp transitions between adjacent layers. For example, the sheet can be a bilayer sheet, having a relatively high-pulp layer at one side, and a relatively low-pulp layer at the other side. The sheet can also be a three-layer sheet, with adjacent high-pulp, low-pulp and high-pulp layers, or the reverse. Further variants are equally feasible.

In a particular embodiment, the sheet material has a low-pulp (front side) surface and an opposite high-pulp (back side) surface, with optionally further layers in between, or without such intermediate layers to form a bilayer sheet. A high-pulp surface may contain at least 60 wt. % of pulp fibres and a low-pulp surface may contain less than 50 wt. % of pulp fibres. Such percentages apply in the outermost regions, e.g. the outermost 5% of the thickness of the sheet. Alternatively, a high-pulp surface may contain less than 30 wt. %, or less than 15 wt. % of thermoplastic fibres, and a low-pulp surface may contain at least 30 wt. %, or more than 50 wt. % of thermoplastic fibres.

The patterns can have any form or design. They can be purely decorative or they can have an information or identification function, or both, and are clearly visible to the user or observer. They can include figures, like lines, circles etc. as well as pictures, readable characters (letters, numbers), etc. For reasons of maximum absorptive power, it is can be beneficial that at least 10% of the total surface area of the imprinted side (or sides) of the sheet material consists of uninterrupted non-imprinted regions of at least 20 cm², or at least 25 cm².

The patterned nonwoven sheet may be of any desired degree of softness, strength, and of any size, and it may be non-coloured (white) or coloured, wherein the colour may be applied before or after the imprinting step. The pattern is stable and resistant to temperature, humidity and other storage conditions, and does not bleed.

The sheet material has few, if any, irregularities such as through-openings (holes). In particular embodiments, the sheet material is free of through openings in the sheet material. Through openings typically extend from one main side to the opposite and can be of circular or elliptic or similar shape. The openings can have an extension along the machine direction (MD) of the sheet material of 0.2-10 mm, or 1-5 mm. A through opening is formed when a contamination is deposited on the anvil during the imprinting of the sheet material, which contamination will cause deformation of any sheet material in contact therewith so that the through opening is formed. This may in fact form a repeating pattern of through openings in the sheet material along the machine direction (MD) of the sheet material, as the deformation will occur every occasion the contamination on the anvil comes in contact with a sheet material during the production. Thus, the typical distance between two or more openings along the MD equals the circumference of the anvil roll. The sheet material of the present disclosure can be free from through openings having an extension along the MD of the sheet material of more than 1 mm. In particular embodiments, the sheet material is free from repetitive (two or more, three or more up to quasi-infinity) through openings having an extension along the MD of more than 0.2 mm. In other embodiments, the sheet material is free of any through opening of more than 0.5 mm in MD, or even of more than 0.2 mm.

A process of producing the nonwoven sheet material of the present disclosure may include:
forming a fibrous web including thermoplastic fibres and cellulosic pulp,
hydroentangling the fibrous web to form a nonwoven sheet material,
drying the nonwoven sheet material to a water content of less than 10 wt. %, or less than 5 wt. %, and subjecting the dried nonwoven sheet material to an imprinting action provided by the energy transmitter on a patterned anvil as described above, wherein contamination of the anvil is reduced as further described above.

The present process, product and equipment will now be described in more detail with reference to embodiments and drawings. In particular, further details of the various process steps and materials to be applied in the forming of a nonwoven sheet material are described below.

### DETAILED DESCRIPTION OF EMBODIMENTS AND MATERIALS AND METHODS TO BE USED

Natural fibres

Many types of natural fibres can be used, especially those that have a capacity to absorb water and tendency to help in creating a coherent sheet. Among the suitable natural fibres there are primarily cellulosic fibres such as seed hair fibres, e g cotton, flax, and pulp. Wood pulp fibres are especially well suited, and both softwood fibres and hardwood fibres are suitable, and also recycled fibres can be used. The pulp fibre lengths can vary from around 3 mm for softwood fibres to around 1.2 mm for hardwood fibres and a mix of these lengths, and even shorter, for recycled fibres.

### Filaments

Filaments are fibres that in proportion to their diameter are very long, in principle endless during their production. They can be produced by melting and extruding a thermoplastic polymer through fine nozzles, followed by cooling, preferably using an air flow, and solidification into strands that can be treated by drawing, stretching or crimping. Chemicals for additional functions can be added to the surface.

Any thermoplastic polymer that has sufficient coherent properties to allow being out in the molten state, can in principle be used for producing spun-bond fibres. Examples of useful synthetic polymers are polyolefins, such as polyethylene and polypropylene, polyamides such as nylon-6, polyesters such as poly(ethylene terephthalate) and polylactides. Copolymers of these polymers may of course also be used, as well as natural polymers with thermoplastic properties.

### Staple Fibres

Staple fibres can be produced from the same substances and by the same processes as the filaments described above. Other usable staple fibres are those made from regenerated cellulose such as viscose and lyocell. They can be treated with spin finish and crimped, but this is not necessary for the type of processes used to produce the present nonwoven sheet material.

The cutting of the fibre bundle normally is done to result in a single cut length, which can be altered by varying the distances between the knives of the cutting wheel. Depending on the intended use, different fibre lengths are used, between 2 and 50 mm. Wet-laid hydroentangled nonwovens may have fibre lengths between 12-18 mm, or down to 9 mm or less, especially hydroentangled materials produced by wet-laying technology. The strength of the material and its other properties like surface abrasion resistance are increased as a function of the fibre length (for the same thickness and polymer of the fibre). When continuous filaments are used together with staple fibres and pulp, the strength of the material will mostly come from the filaments.

### Process

The sheet material of the present disclosure, such as a pulp-containing sheet, can be formed from materials that can be applied by various techniques known in the art, including wet-laying, air-laying, dry laying or spun-laying or it can completely or partly be formed from a pre-fabricated sheet, e.g. a tissue sheet. As an example, the process for producing the patterned nonwoven sheet material of the present disclosure can be as depicted in the figure. Such a process includes: providing an endless forming fabric 1, on which the continuous filaments 2 can be laid down as, for example, spun-bond filaments, and excess air can be sucked off through the forming fabric 1, to form a precursor of a web 3; advancing the forming fabric 1 with the continuous filaments to a wet-laying stage and a so-called head box 4, where an aqueous slurry or an aqueous foam including a mixture 5 of natural fibres and staple fibres is wet-laid on and partly into the precursor web 3 of continuous filaments 2, and excess water is drained off through the forming fabric 1 foiming a fibrous web 6; advancing the fibrous web 6 from the fabric 1 to a second fabric 7 to subject the fibre mixture to a hydro-entangling stage 8, where the filaments 2 and fibres are intermingled intimately and bonded into a nonwoven web 9 by the action of water jets 10. The web is then advanced to a drying stage 11 where the nonwoven web 9 is dried; and further advanced to stages for imprinting between anvil 20 and horn 21, further described below, subsequently for rolling, cutting, packing, etc. (stages 12).

The continuous filaments 2, which can be made from extruded thermoplastic pellets, can be deposited directly onto a forming fabric 1 where they are allowed to form an unbonded web structure 3, in which the filaments can move relatively freely from each other. Before the pulp-containing mixture 5 (with or without staple fibres) is deposited through head box 4, the precursor filament web 3 may be subjected to a prebonding stage, or even be supplied as a prebonded web that can be treated as a normal web by rolling and unrolling operations, even if it still does not have the final strength to its use as a wiping material (not shown).

As illustrated in the figure, the precursor filament web 3 may be substantially unbonded prior to the laying of the pulp-containing mixture 5, i.e. no extensive bonding (e.g. thermal bonding) of the precursor filament web 3 should occur before the pulp-containing mixture 5 (with or without staple fibres) is laid down through head box 4. The filaments should be completely free to move in respect of each other to enable the staple and pulp fibres to mix and twirl into the filament web during entangling.

An advantageous technique of wet-laying the cellulosic fibres (and staple fibres) is by foam formation, in which the cellulosic pulp and staple fibres are mixed with water and air, in the presence of a surfactant so as to form the pulp-containing mixture 5. The foam may contain between 10 and 90 vol. %, between 15 and 50 vol. %, or between 20 and 40 vol. % of air (or other inert gas). It is transported to the head box 4 where it is laid on top of the filament web 3 and surplus water and air are sucked off.

Instead of, for example, wet-laying, the fibres can be applied by dry-laying (in which fibres are carded and then directly applied on the carrier) or air-laying (in which fibres, which may be short, are fed into an air stream and applied to form a random oriented web).

In the hydroentangling stage 8, the fibrous web 6 of synthetic fibres such as continuous filaments, and staple fibres and pulp is hydroentangled, while it is supported by the fabric 7 and is intensely mixed and bonded into a composite nonwoven material web 9. An instructive description of the hydroentangling process is given in CA patent no. 841,938.

All fibre types in the entangled composite nonwoven material 9 are substantially homogeneously mixed and integrated with each other. The fine mobile spun-laid filaments are twisted around and entangled with themselves and the other fibres which give a material with a very high strength.

The strength of a hydroentangled material will depend on the amount of entangling points, and thus on the lengths of the fibres, in particular when the material that is hydroentangled is only based on staple and pulp fibres. When filaments are used, the strength will be based mostly on the filaments, and reached fairly quickly in the entangling. Thus, most of the entangling energy will be spent on mixing filaments and fibres to reach a good integration. The unbonded open structure of the filaments will greatly enhance the ease of this mixing.

The hydroentangled wet web 9 is then dried, which can be done using a conventional web drying equipment 11, for example of the types used for tissue drying, such as through-air drying or Yankee drying, before being forwarded to the imprinting (ultrasound) stage as summarised below and described in more detail above.

In the imprinting stage, the hydroentangled nonwoven web 9 is conveyed over anvil 20 along guiding rolls 22 to produce treated sheet material 23. The anvil roll 20 is activated by driving gear 24, which in this figure rotates clockwise. Ultrasound energy is applied by horn 21 provided with sonotrode 25 and oscillation boosters 26. A felt 27 with oil supply 28 is pressed against the anvil and brush 29 is pressed against the anvil at a certain distance from the oil-proving felt, and is provided with a scraper 30 for removing and carrying off spent oil from the brush.

Before and after the imprinting of the web 9, the structure of the material can be changed by further processing such as microcreeping, etc. To the material can also be added different additives such as wet strength agents, binder chemicals, latexes, debonders, etc. nonwoven material. After the imprinting step, the material can be wound into mother rolls before converting. The material is then converted in known ways to suitable formats and packed. A composite patterned nonwoven can be produced with a total basis weight of 20-120 g/m², or 40-80 g/m². The unbonded filaments will improve the mixing-in of the staple fibres, such that even a short fibre will have enough entangled bonding points to keep it securely in the web.

### EXAMPLES

### Test Method—Basis Weight

The basis weight (grammage) can be determined by a test method following the principles as set forth in the following standard for determining the basis weight: WSP 130.1.R4 (12) (Standard Test Method for Mass per Unit Area). In the Standard Method, test pieces of 100×100 mm are punched from the sample sheet. Test pieces are chosen randomly from the entire sample and should be free of folds, wrinkles and any other deviating distortions. The pieces are conditioned at 23° C., 50% RH (Relative Humidity) for at least 4 hours. A pile of ten pieces is weighed on a calibrated balance. The basis weight (grammage) is the weighed mass divided by the total area (0.1 m²), and recorded as mean value with standard deviations.

### Test Method—Thickness

The thickness of a sheet material as described herein can be determined by a test method following the principles of the Standard Test Method for Nonwoven Thickness according to EDANA, WSP 120.6.R4 (12). An apparatus in accordance with the standard is available from IM TEKNIK AB, Sweden, the apparatus having a Micrometer available from Mitutoyo Corp, Japan (model ID U-1025). The sheet of material to be measured is cut into a piece of 200×200 mm and conditioned (23° C., 50% RH, ≥4 hours). During measurement the sheet is placed beneath the pressure foot which is then lowered. The thickness value for the sheet is then read off after the pressure value is stabilised. The measurement is made by a precision micrometer, wherein a distance created by a sample between a fixed reference plate and a parallel pressure foot is measured.

The measuring area of the pressure foot is 5×5 cm. The pressure applied is 0.5 kPa during the measurement. Five measurements are performed on different areas of the cut piece to determine the thickness as an average of the five measurements.

### Test Method: Irregularities —Through Openings in Sheet Materials

A sheet material formed in the example was visually scanned for through openings (through holes) in the sheet material. The maximum extension of the opening (e.g. diameter) along the machine direction (MD) of the sheet material was measured and recorded.

The machine direction (MD) is the direction of the production as illustrated in the figure.

### Example 1 (Comparative)

An absorbent sheet material of nonwoven that may be used as wipe such as an industrial cleaning cloth was produced by laying a web of polypropylene filaments on a running conveyor fabric and then applying on the polymer web a pulp dispersion containing a 88:12 weight ratio of wood pulp and polyester staple fibres, and 0.01-0.1 wt. % of a non-ionic surfactant (ethoxylated fatty alcohol) by foam forming in a head box, introducing a total of about 30 vol. % of air (on total foam volume). The weight proportion of the polypropylene filaments was 25 wt. % on dry solids basis of the end product. The amounts were chosen so as to arrive at a basis weight of the end product of 80 g/m². The combined fibre web was then subjected to hydroentanglement using multiple water jets at increasing pressures of 40-100 bar providing a total energy supply at the hydroentangling step of about 180 kWh/ton as measured and calculated as described in CA 841938, pp. 11-12 and subsequently dried.

The hydroentangled and dried sheet was then imprinted in an ultrasound apparatus as depicted in the accompanying FIG. 1, without applying and removing oil using the oil felt 27/28 and the brush 29/30. The anvil roll had a protruded part of approximately 15% of the surface area, forming lines and text patterns. The anvil roll was treated with NTS (Nano-to-Surface) treatment, to reduce sticking of polymers and contaminants (supplied by A.+E. Ungricht GmbH & Co, Mönchengladbach, Del.). Running the nonwoven at high speed resulted in deposits on the anvil and holes in the nonwoven within two minutes. The formed nonwoven sheet material also had a repeating pattern of circular and elliptic-shaped through openings (through holes), each having a maximum dimension of 1-5 mm along the length (MD) of the sheet material.

This Example shows that the NTS treatment does not solve the problem of deposition of contaminants, sticking, and damaging the nonwoven.

### Example 2

The same sheet material as produced according to Example 1 was imprinted in the ultrasound apparatus as depicted in the figure, including the oil felt and supply 26/27 and the brush and 28/29. The anvil roll had a patterned protruded part of approximately 20% of the surface area and was not NTS-treated. The nonwoven was run through the ultrasound treatment at high speed until about 1275 m had been treated. The oil felt released about 2 oil per m² sheet material. Some dirt appeared between the patterns but not on the upper parts of it. The formed nonwoven sheet material was free of any through openings (holes). Continued running proceeded satisfactorily with a good patterning result.

The oil felt and the brush were then removed and the anvil roll was cleaned and degreased. The imprinting was started again. After 500 running meters, the first deposit had built up on top of the patterns and could not be removed without mechanical abrasion. After 1275 running meters, the process was stopped again and so much dirt had been deposited on the anvil that there were holes in the nonwoven material.

It is concluded that high-speed imprinting using ultrasound on a patterned anvil roll cannot be performed without frequent cleaning unless the anvil roll is oiled and cleaned continuously as described herein.

1. A process for producing a sheet material comprising:
passing the sheet material between a device emitting energyand a patterned anvil;
applying an oil to the anvil after the passing of the sheet material; and
removing the oil from the anvil before the next passing of the sheet material.

2. The process according to claim 1, wherein the oil is a saturated hydrocarbon or a saturated siloxane having at least 20 carbon and/or silicon atoms.

3. The process according to claim 1, in which wherein the oil has a viscosity of 20-100 mm²/s 40° C.

4. The process according to claim 1 wherein between 0.1 and 5 μl of the oil is applied per m² of the sheet material.

5. The process according to claim 1 wherein removing the oil includes subjecting the anvil to brushing after the anvil contacts the sheet material.

6. The process according to claim 1 wherein the device emitting energy emits ultrasonic energy.

7. The process according to claim 6, wherein the passing the sheet material between a device emitting energy and a patterned anvil comprises ultrasonic imprinting the sheet material to produce a patterned sheet material having an imprinted part and a non-imprinted part.

8. The process according to claim 7, wherein the imprinted part has a thickness which is between 75 and 95% of a thickness of the non-imprinted part.

9. The process according to claim 1 wherein the sheet material has a sheet thickness of 250-2000 μm.

10. The process according to claim 1 wherein the sheet material contains 40-80 wt. %, of pulp fibres and 15-60 wt. %, of thermoplastic fibres.

11. A patterned nonwoven sheet material obtained by the process according to claim 10 wherein the sheet material further contains between 0.1 an 5 ppm of oil.

12. A patterned nonwoven sheet material obtained by the process according to claim 10 wherein the sheet material is free of through openings having an extension along a machine direction (MD) of the sheet material of more than 1 mm.

13. The sheet material according to claim 12, wherein the sheet material is free of repetitive through openings having an extension along the machine direction (MD) of the sheet material of more than 0.2 mm.

14. An apparatus for continuously imprinting a sheet material, comprising:
a patterned anvil roll,
an energy transmitter emitting ultrasound energy to the anvil roll at a distance from the anvil roll,
a means for rotating the anvil roll,
a means for applying an oil over the breadth of the anvil roll downstream of the energy transmitter, and
a means for removing oil from the roll downstream of the means for applying the oil.

15. The apparatus according to claim 14, wherein the distance between the energy-emitting unit and the anvil roll has an adjustable clearance between 600 and 2000 μm.

16. The apparatus according to claim 14, wherein the means for rotating the anvil roll is capable of rotating the anvil at a tangential speed of between 2 and 10 m per sec.

17. The apparatus according to claim 14, wherein the means for removing oil comprises a brush or an air jet.
